(19) United States
(12) Patent Application Publication
(10) Pub. No.: US 2025/0033072 A1
(43) Pub. Date: Jan. 30, 2025

(54) DISPENSING DEVICE FOR A FLUID

(71) Applicant: Aero Pump GmbH, Hochheim/Main (DE)

(72) Inventors: Sebastian ROTHER, Mainz (DE); Milena Angelika MARSZALEK, Mainz (DE); Andreas MERSMANN, Hochheim/Main (DE)

(73) Assignee: Aero Pump GmbH, Hochheim/Main (DE)

(21) Appl. No.: 18/785,259

(22) Filed: Jul. 26, 2024

(30) Foreign Application Priority Data
Jul. 27, 2023 (EP) 23188135.0

(51) Int. Cl. B05B 11/00; B05B 1/06

(52) U.S. Cl. CPC B05B 11/0067; B05B 1/06

(57) ABSTRACT

A dispensing device for dispensing a fluid has a head base piece having a dispensing opening, a liner arranged inside of the head base piece, and a valve element movably arranged inside of the liner. The valve element is arranged to be movable from a first position into a second position via a stroke relative to the liner. The valve element closes off the dispensing opening in the first position and clears the dispensing opening in the second position. The valve element and the liner, which seal against one another in the first position and in the second position, form a nozzle chamber and a valve chamber. The dispensing device includes a channel, which connects the valve chamber and the nozzle chamber to one another, enables the use as a spray device.

### CROSS-REFERENCE TO RELATED APPLICATION

This application claims priority under 35 U.S.C. § 119 (a) to Europe application Ser. No. 23/188,135.0 filed Jul. 27, 2023, the disclosure of which is expressly incorporated by reference herein in its entirety.

### BACKGROUND

### 1. Field of the Invention

Embodiments relate to a dispensing device for dispensing a fluid. A dispensing device of this type can include a head base piece having a dispensing opening, a liner arranged inside of the head base piece, and a valve element movably arranged inside of the liner. The valve element is arranged such that it can be transferred from a first position into a second position via a stroke relative to the liner. The valve element can thereby close off the dispensing opening in the first position and clear the dispensing opening in the second position.

### 2. Discussion of Background Information

Dispensing devices for dispensing fluids exist in particular in the form of sprays and droppers. EP 3 072 597 A1 describes a dropper dispensing device for dispensing predetermined amounts of fluid in the form of drops. However, in order that the fluid being dispensed does not exit the dispensing opening at a great speed during a small stroke of the valve element in said dispensing device, the valve element, or the cylinder thereof, interacts with the dispensing opening, so that, in a closed state, the dispensing opening is sealed by the valve element and even a small stroke does not clear the dispensing opening. Likewise, a volume of the nozzle chamber is chosen such that the fluid is decelerated before exiting the dispensing opening. Only a sufficiently large stroke of the valve element clears the fluid path from a chamber arrangement to a nozzle chamber, together with the dispensing opening.

This structural design of the dispensing device allows the use of the dispensing device as a dropper, that is, for use for eye drops, for example. A dropper is thereby characterized by a discharge of fluid in the form of drops, wherein the fluid has a low fluid discharge velocity.

However, a disadvantage of the use of droppers is that said droppers often require the practiced and precise instilling of fluid. In the case of eye or nose droppers, for example, the instilling of fluid into the conjunctival sac or the nose requires both skill and practice. Accordingly, sprays are often used, which have the advantage over droppers that the sprays can also be sprayed onto a closed eye or into the nose or the mouth against the direction of gravity, and are thus significantly easier to use than droppers. In addition, the use of sprays can also have other advantages, for example, the sprayed fluid can be better dispersed and penetrate more deeply.

As a result of the higher fluid discharge velocities required for sprays, dispensing devices of this type normally have a design that is complex compared to droppers. Among other things, this is due to the fact that a larger pressure is needed during the dispensing of fluid, with a sufficient leak-tightness needing to be ensured at the same time. Accordingly, dispensing devices for sprays must be more elaborately sealed and, at the same time, permit a high buildup of pressure. The complexity of the design is often reflected in the production costs.

### SUMMARY

Embodiments provide a dispensing device which allows the use as a spray device and at the same time has a simple design.

According to embodiments, the valve element and liner in a dispensing device of the type named above seal against one another in the first position and in the second position of the valve element, thus, forming a nozzle chamber and a valve chamber, wherein the dispensing device includes a channel which connects the valve chamber and the nozzle chamber to one another.

The chosen design allows the combination of a seal and a buildup of pressure in a simple arrangement of components and, due to its simplicity, is especially economical and hardly susceptible to errors.

The fluid that the dispensing device can dispense is preferably a medical or cosmetic active ingredient solution, for example for use in the nose, mouth, or eyes of a user of the dispensing device. In addition, the dispensing preferably occurs in a spray form, that is, the dispensing device is preferably a spray dispenser device. The head base piece of the dispensing device essentially forms the enclosure part of the dispensing device that is configured to dispense the fluid and, accordingly, comprises a dispensing opening. The head base piece can be provided with a closing cap which must be removed from the head base piece prior to the use of the dispensing device.

Inside of the head base piece, a liner is arranged which extends away from the dispensing opening in an axial direction, that is, in a longitudinal direction of the dispensing device. The liner is a tubular, essentially cylindrical body with a wall and a cavity. Correspondingly, the liner comprises an inner wall and an outer wall. The liner can also be embodied in one piece. Furthermore, a valve element is arranged inside of the liner, which valve element is arranged such that it can be moved relative to the liner. The valve element can thus be displaced relative to the liner in an axial direction, for example. The valve element can thereby be transferred from a first position into a second position via a stroke relative to the liner. In the first position, the valve element closes off the dispensing opening. In the second position, the valve element clears the dispensing opening. This means that, in the second position, the dispensing opening is no longer closed off by the valve element and is cleared for a discharge of fluid. The dispensing device, or the nozzle chamber together with the dispensing opening, thereby preferably forms a nozzle, in particular a hollow-cone nozzle.

Preferably, the valve element is not transferred into the second position until the fluid in the valve chamber has a pressure of at least 3 bar. However, the pressure in the valve chamber can also be greater than 3 bar depending on the application case or embodiment of the dispensing device. Particularly for the application as a nasal spray, the dispensing device preferably opens at 3 bar or more.

In addition, the dispensing device includes a nozzle chamber and a valve chamber which are formed in that the valve element and the liner seal against one another both in the first position of the valve element and also in the second position of the valve element. The nozzle chamber thereby denotes a chamber of the dispensing device in the region of the dispensing opening. By contrast, the valve chamber denotes a chamber on the opposite side of the nozzle chamber, wherein the region relevant to the seal between the valve element and liner is arranged between the two chambers. The valve element is thus arranged in a region between the chambers and separates said chambers from one another. The seal between the valve element and liner can thereby occur using sealing elements, such as sealing lips for example, or using surface pressure for example. The valve chamber can thereby comprise a region in the interior and outside of the liner, wherein at least one region of the valve chamber is arranged in the interior of the liner.

Furthermore, the dispensing device c includes a channel, in particular a nozzle channel, which connects the valve chamber and the nozzle chamber to one another. Thus, the channel is configured such that a fluid can flow from the valve chamber into the nozzle chamber. Accordingly, the channel comprises a channel opening, which allows the entry of fluid into the nozzle chamber, also referred to as the outlet opening of the channel, and an inlet opening, which allows the ingress of fluid from the valve chamber into the channel. The fluid flow in the channel thereby always occurs past the seal between the valve element and liner, since the seal is never broken, regardless of the position of the valve element. The seal is therefore stable, continuous, and lasting.

The dispensing device is thus in particular characterized in that a fluid flow from the valve chamber to the nozzle chamber cannot take place past the valve element. In this respect, “past” means that no fluid path between the valve chamber and the nozzle chamber is formed that allows a continuous contact between the fluid and the valve element during the fluid flow from the valve chamber into the nozzle chamber. Only by bypassing through the channel can a fluid path be formed between the valve chamber and the nozzle chamber. This fluid path thus leads past the seal. However, this does not rule out that the dispensing device can also comprise multiple channels for forming the fluid path. A channel thereby has a smaller cross section than the valve chamber, so that the fluid is accelerated in the channel.

The dispensing device can additionally include a liner channel to feed the valve chamber. Preferably, the liner channel is located between the head base piece and the liner arranged in the head base piece. Accordingly, the liner channel is preferably formed between the outer wall of the liner and the inner wall of the head base piece. Preferably, the liner channel ends in the valve chamber, that is, preferably in a region in the interior of the liner. Accordingly, the liner channel enables the fluid to be transported from the outer wall of the liner into the interior of the liner. The liner channel can thereby be fed, for example, from a pump chamber or a fluid channel connected thereto, and can be used to conduct a fluid into the valve chamber. For this purpose, a breach can be arranged, e.g., in the liner, where the breach allows for passage of fluid from the liner channel the interior of the liner.

Accordingly, a stroke movement of the valve element is sufficient to conduct a fluid that is under pressure in the valve chamber through the channel into the nozzle chamber and, from there, allow the fluid to exit the dispensing opening of the dispensing device. Due to a smaller cross section of the channel compared to the valve chamber, the fluid in the channel is additionally accelerated, which facilitates the spray function of the dispensing device and ensures an increased fluid discharge velocity from the dispensing opening. The spray can preferably be used as a nasal spray in particular. However, the use for the eyes or the mouth or other applications is, as it were, possible depending on the fluid being used.

In a first embodiment, the channel is a vortex channel and, correspondingly, is embodied, at least in regions, in the shape of a helix. Consequently, a vortex channel shall be understood as a channel in which the fluid path runs essentially in the shape of a circular arc, and wherein an inlet opening into the channel from the valve chamber is arranged such that it is offset from an outlet opening of the channel into the nozzle chamber. This means that a guide curve of the channel preferably constitutes a helix. Preferably, the channel path traveled thereby corresponds to at least a half winding. The vortex channel can, however, also comprise multiple windings. The helix or the channel is thereby preferably arranged such that, in a plan view, it winds about the dispensing opening of the dispensing device. Because the channel is helical in shape, the fluid flows faster farther inward in the channel than farther outward, so that fluid vortices occur inside of the channel, which vortices give the channel its name, vortex channel. The swirling of the fluid offers the advantage that, particularly in the case of fluids which have multiple components, for example an active ingredient and a carrier medium, the components are thoroughly mixed before exiting the dispensing opening, or before entering into the nozzle chamber through the channel opening. Additionally, the fluid can be better sprayed due to the swirling.

In addition, according to a further embodiment, the channel is embodied, at least in regions, in the liner. Alternatively, however, the channel can also be embodied entirely inside of the liner. Here, the channel can have any desired shape, or else the helical shape described above. The inlet opening of the channel is thereby accessible to a fluid from the valve chamber. The outlet opening of the channel, or the channel opening, opens into the nozzle chamber. The arrangement of the channel inside of the liner offers the advantage that the channel is additionally protected by the head base piece. At the same time, no other components are needed for the channel.

Additionally, in a further embodiment, the valve element can close off a channel opening into the nozzle chamber when the valve element is located in the first position. This means that the valve element is arranged, at least in regions, ahead of the channel opening into the nozzle chamber, that is, ahead of the outlet opening of the channel, such that a fluid cannot enter into the nozzle chamber from the channel. For this purpose, an envelope surface of the valve element can overlap and close off the channel opening. In addition, it can be advantageous if the outlet opening of the channel is arranged such that a small stroke of the valve element does not clear the outlet opening. The closing-off of the channel opening into the nozzle chamber in the first position of the valve element offers the advantage that no ingress of fluid into the nozzle chamber takes place as long as the pressure in the valve chamber, for example, is not sufficient to (adequately) move the valve element, or as long as a movement of the valve element was not enabled by a user. Once the valve element is moved from the first position into the second position, a fluid can flow from the valve chamber into the nozzle chamber, so that the channel produces a fluid connection between the two chambers. Because the channel opening is closed off in the first position of the valve element, it can be prevented that fluid already flows into the nozzle chamber at low pressure, which would impair the spray function of the dispensing device.

In addition, in one embodiment, the nozzle chamber can have a smaller volume than the valve chamber in the first position of the valve element and in the second position of the valve element. This means that, regardless of the valve position, the nozzle chamber always has a smaller volume than the valve chamber. In particular, a stroke movement of the valve element can alter the volume of the chambers. Preferably, the volumes of the valve chamber and of the nozzle chamber are increased by a transfer of the valve element from the first into the second position. Because the nozzle chamber always has a smaller volume than the valve chamber, the pressurized fluid from the valve chamber is accelerated through the channel, and is not or only negligibly decelerated in the nozzle chamber. Preferably, the volume of the valve chamber is thereby at least ten times larger than the volume of the nozzle chamber. However, the volume of the valve chamber can also be twenty times or more than the nozzle chamber volume.

In a further embodiment, the channel is configured to introduce a fluid tangentially into the nozzle chamber. The channel opening into the nozzle chamber, that is, the outlet opening of the channel, is for this purpose arranged on an inner wall of the liner. The fluid thus enters into the nozzle chamber essentially perpendicularly to the discharge direction from the dispensing opening of the dispensing device. A tangential introduction of the fluid into the nozzle chamber sets the fluid in rotation in the nozzle chamber. At the dispensing opening of the dispensing device, the rotational movement of the fluid is converted into an axial movement, whereby a very fine spray mist is formed.

According to a further embodiment, the dispensing device includes a head spring which presses the valve element against the dispensing opening in the first position. The head spring thus ensures the formation of a force fit between the valve element and dispensing opening. Accordingly, a force must be applied which is larger than the spring force in order to transfer the valve element from the first position into the second position of the valve element. For this purpose, the fluid pressure of the fluid which collects inside of the valve chamber or builds up against the spring force can be used, for example. Furthermore, the head spring can be configured to move the valve element from the second position back into the first position, so that the dispensing device is transferred back into the initial position (the first position) after a dispensing of fluid has occurred. Depending on the spring force of the head spring, it is thus possible to determine the force which must be applied to open the dispensing opening, that is, the force that is needed to move the valve element. Through this approach, a targeted dispensing of fluid from the dispensing opening of the dispensing device can occur at a desired pressure and desired velocity.

Furthermore, the valve element can additionally comprise a sealing lip, wherein the sealing lip seals the valve chamber against the head spring. The fluid that collects inside of the valve chamber thus cannot advance to the head spring, whereby the head spring can be protected against an undesired influence of the fluid, for example against corrosion. The scaling lip can furthermore form a type of screen on which the pressure in the valve chamber acts. The compressive force on the screen is thereby directed against the spring force of the head spring, so that the head spring is compressed when there is sufficient fluid pressure. The region in which the head spring is arranged can be referred to as the spring space. The valve chamber is thus sealed both against the nozzle chamber and against the spring space. An ingress of fluid into the valve chamber, for example via a liner channel, can ensure a collection of fluid in the valve chamber, wherein the fluid presses on the sealing lip and, when there is sufficient pressure, moves the valve element from the first position into the second position. Furthermore, the scaling lip can be used to guide the valve element inside of the liner.

According to an alternative embodiment, the dispensing device, and preferably the liner, comprises a stop, wherein the stop limits the stroke movement of the valve element from the first position into the second position. The stop can thereby be embodied as a projection on the inner wall of the liner, for example. If the dispensing device includes a head spring, the stop is preferably arranged such that the movement of the valve element is limited by the stop such that the movement is smaller than a movement of the valve element without a stop. This means that no force equilibrium is present between the compressive force and the spring force in the second position of the valve element. The use of a stop, and the accompanying limitation of the movement of the valve element, ensures a more consistent application of the fluid, and can therefore improve the fluid spray pattern produced using the dispensing device.

Additionally, the valve element can include a hemispherical closing surface that bears against the dispensing opening in the first position. Because the closing surface of the valve element is also partially arranged in the nozzle chamber during the dispensing of fluid, a hemispherical closing surface ensures a more uniform fluid flow inside of the nozzle chamber compared to a closing surface provided with edges, for example. Accordingly, the fluid flow in the nozzle chamber can be better controlled.

In addition, the dispensing opening can include a cone which interacts with the closing surface of the valve element. The cone is included as part of the dispensing opening. The cone is thereby embodied in the form of a truncated cone, wherein the base surface of the cone, that is, the surface with a larger radius, faces the nozzle chamber and tapers in the direction of a top surface, which has a smaller radius and is arranged farther away from the nozzle chamber. The use of a cone at the dispensing opening ensures a uniform fluid flow from the nozzle chamber to the dispensing opening. The cone can thereby convert the rotational movement of the fluid in the nozzle chamber into an axial movement particularly well, for example. If the closing surface of the valve element is embodied to be hemispherical, the closing surface of the valve element can additionally interact particularly effectively with the cone. Preferably, the cone thereby has the shape of a truncated cone, wherein the radius of the hemispherical closing surface is preferably chosen such that the closing surface protrudes, in regions, past the truncated cone, that is, past the top surface of the truncated cone, and in particular protrudes into a passage. As a result, a particularly tight contact between the closing surface and cone or dispensing opening can be achieved.

Furthermore, the dispensing opening can comprise a radial surface which forms a portion of the outer contour of the head base piece. The radial surface thereby preferably forms a recess in the outer counter, and not a bulge. The wall thickness in the region of the recess can thus, at least in regions, be reduced compared to the wall thickness of the head base piece in other regions. Since the radial surface is embodied as a recess, a contact of the opening which conducts the fluid into the radial surface is also rendered more difficult during the use of the dispensing device. This is because regions of the outer contour of the head base piece project farther into the radial surface than the fluid opening, which discharges fluid from the nozzle chamber out of a passage, for example. In addition, the use of a radial surface also allows the reduction of the length of the passage, or the reduction of the wall thickness of the head base piece in the region of the passage. As a result, the probability of an undesired contact of the opening, for example with the skin of a user, during the use of the dispensing device can be reduced. The radial surface can furthermore be used to define the spray pattern or the spray cone of the fluid. The radial surface can also ensure a more uniform fluid flow. If the dispensing device comprises both a cone and a radial surface, the cone is significantly smaller in relation to the radial surface. This means that the radius of the base surface of the cone is smaller than the radius of the radial surface. Between the cone and the radial surface, a passage can thereby be arranged which allows a fluid flow from the cone to the radial surface.

In addition, in one embodiment the dispensing opening includes a cone which interacts with the closing surface of the valve element, a radial surface which forms a portion of the outer contour of the head base piece, and a passage, wherein the passage connects the cone and the radial surface. Accordingly, the passage is configured so that a fluid can flow from the cone to the radial surface through the passage. The passage is thereby preferably designed in a cylindrical shape, wherein the radius of the passage is preferably smaller than the radius of the base surface of the cone and smaller than the radius of the radial surface. The passage preferably has a diameter (passage diameter) between 0.2 and 0.6 mm or a radius of 0.1 to 0.3 mm. A diameter of 0.3 mm or a radius of 0.15 mm is particularly preferred. The radial surface preferably has a radius of 3 mm. The base surface of the cone preferably has a radius of 0.5 mm. An angle of the cone preferably lies in the range of 100° to 140°. As a result of this arrangement, a fluid which flows from the nozzle chamber to the dispensing opening, can initially be transferred into an axial movement by the cone. Depending on the specific design of the cone and of the passage, the radius of which is reduced compared to the radius of the base surface of the cone, the fluid flow can be influenced and, in particular, accelerated. Finally, the fluid can exit the dispensing opening in a spray cone, wherein the radial surface can facilitate the spray pattern. In addition, because of the radial surface, especially if said surface is designed in the form of a recess, the probability of a contact of the passage in the region of the radial surface, for example a contact with the skin of a user, can be reduced.

In a further embodiment, the liner can include a breach which is configured such that a fluid can flow through the breach into the liner. If a fluid is transported through a liner channel, the fluid can enter into the interior of the liner through the breach and, from there, act on the sealing lip, for example, and thus move the valve element. Furthermore, as a result of the use of a breach, the liner can be braced on the head base piece so that, without the use of additional components, the valve element and the liner can be sealed against one another and the nozzle chamber can be formed.

Additionally, the dispensing device can be configured such that the dispensing opening produces a maximum spray cone of 70° in a second position of the valve element. Since the pressure in the valve chamber decreases during the discharge of the fluid from the dispensing opening, the spray cone is variable over time. Particularly, the use of a stop described above can, however, ensure a consistent spray cone over a longer period of time. This is because the stop already defines the second position of the valve element before a force equilibrium is present between the spring force of the head spring and the force applied by the fluid pressure. Thus, a change in the valve position does not occur, even if a certain amount of fluid has already exited from the dispensing opening. However, for the use of the dispensing device and the adequate wetting of a location on the body associated therewith, for example, a sufficiently large spray cone is required. Accordingly, the maximum angle of the spray cone is preferably 70°. The minimum angle of the spray cone is preferably 15°. Particularly preferably, the angle lies in a range of 30° to 45°.

Embodiments are directed to a dispensing device for dispensing a fluid that includes a head base piece having a dispensing opening; a liner arranged inside of the head base piece; and a valve element movably arranged inside of the liner. The valve element is arranged to be movable from a first position into a second position via a stroke relative to the liner, and the valve element closes off the dispensing opening in the first position and clears the dispensing opening in the second position. The valve element and the liner, which seal against one another in the first position and in the second position, form a nozzle chamber and a valve chamber. A channel connects the valve chamber and the nozzle chamber to one another.

In accordance with embodiments, the channel can be a vortex channel that is embodied, at least in regions, in a shape of a helix.

In embodiments, the channel may be embodied, at least in regions, inside of the liner.

According to other embodiments, the valve element can close off a channel opening into the nozzle chamber when the valve element is located in the first position.

In other embodiments, the nozzle chamber can have a smaller volume than the valve chamber in the first position and in the second position.

In still other embodiments, the channel may be configured to introduce a fluid tangentially into the nozzle chamber.

In accordance with further embodiments, dispensing device may include a head spring that presses the valve element against the dispensing opening in the first position. The valve element can additionally include a sealing lip arranged to seal the valve chamber against the head spring.

According to still further embodiments, the dispensing device can include a stop that limits the movement of the valve element via the stroke from the first position into the second position. Further, the liner can include the stop that limits the movement of the valve element via the stroke from the first position into the second position.

According to other embodiments, the valve element may include a hemispherical closing surface which bears against the dispensing opening in the first position.

In accordance with other embodiments, the dispensing opening may include a cone which interacts with the hemispherical closing surface. The dispensing opening can include a radial surface which forms a portion of an outer contour of the head base piece. Further, the dispensing opening may include a passage that connects the cone and the radial surface.

In still other embodiments, the liner may include a breach which is configured such that a fluid can flow through the breach into the liner.

In accordance with still yet other embodiments, the dispensing opening may produce a maximum spray cone of 70° in a second position of the valve element.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically shows a sectional illustration of an embodiment of a dispensing device according to the invention in a first (closed) position;

FIG. 2 schematically shows a detailed view of a section X from FIG. 1;

FIG. 3 schematically shows a sectional illustration of a dispensing device according to FIG. 1 in a second (open) position;

FIG. 4 schematically shows a detailed view of a section Y from FIG. 3;

FIG. 5 schematically shows a detailed view of a section Z from FIG. 4; and

FIG. 6 schematically shows an exemplary fluid flow in a nozzle chamber and a dispensing opening according to FIGS. 1 through 6.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

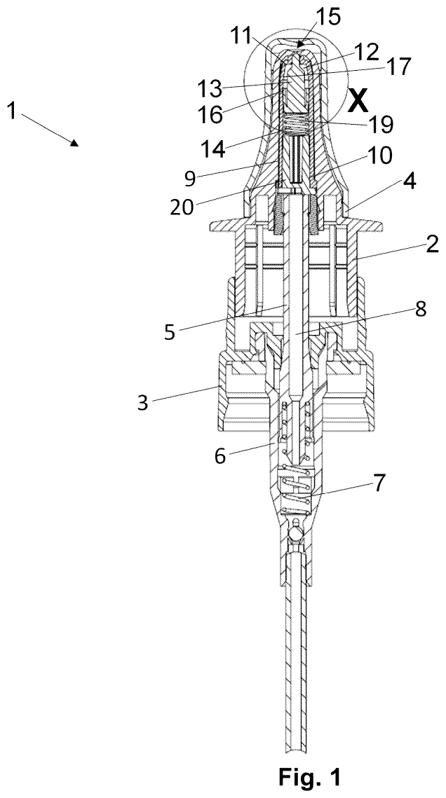

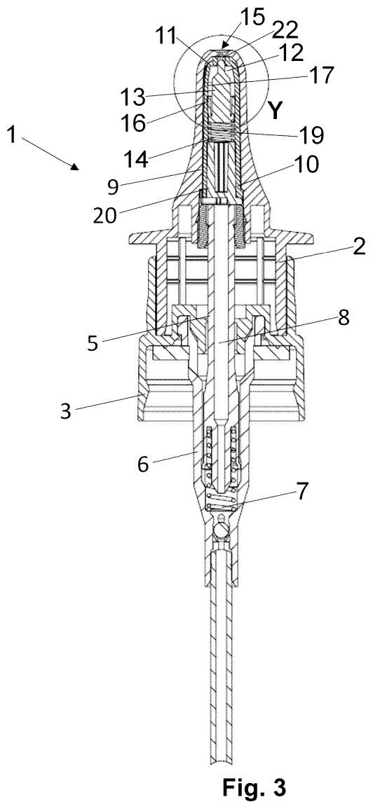

FIG. 1 shows an embodiment of a dispensing device 1 for dispensing a fluid, preferably in a spray form. The dispensing device 1 comprises a head base piece 2 that is arranged on a snap-on element 3. The head base piece 2 is provided with a removable closing cap 4 which, during the use of the dispensing device 1, can be removed therefrom (see FIGS. 3 through 6). A cone 5 extends from the head base piece 2 into an enclosure 6 through the snap-on element 3 in an axial direction. The cone 5 interacts with an enclosure spring 7 in the enclosure 6. The cone 5 comprises a fluid channel 8. The fluid channel 8 extends towards the head base piece 2 in an axial direction.

The fluid channel 8 continues into a liner channel 9 in the head base piece 2. Said liner channel 9 is arranged between the head base piece 2 and a liner 10. The liner 10 is embodied in one piece. The liner 10 is braced on the head base piece 2. Furthermore, the liner 10 comprises a breach 11, whereby the liner channel 9 opens into a valve chamber 12.

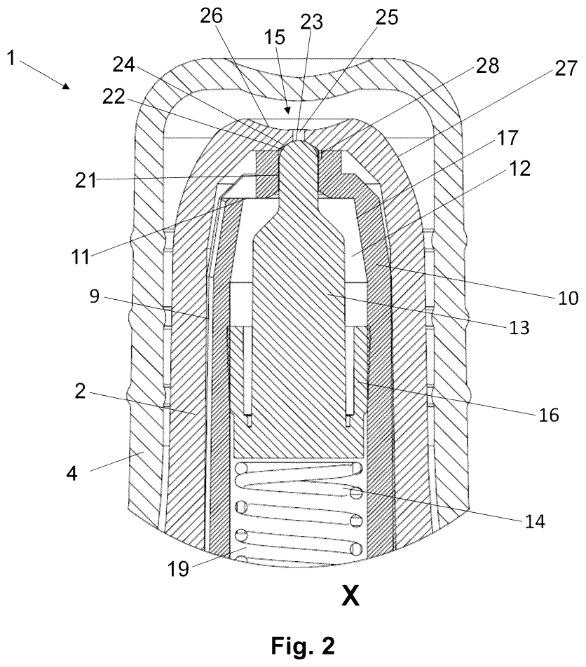

In addition, the dispensing device 1 comprises a valve element 13 which sits such that it is movably arranged in the liner 10. In the first position of the valve element 13 illustrated here, the valve element 13 is pressed against a dispensing opening 15 by a head spring 14. The dispensing opening 15 is thus closed off by the valve element 13. The dispensing opening 15 can be better seen in FIGS. 2, 4, 5, and 6, and is subsequently described in greater detail.

The valve element 13 comprises a sealing lip 16 which bears against an inner wall 17 of the liner 10. At an end of the valve element 13 opposite from the sealing lip 16, the valve element 13 comprises a hemispherical closing surface 23, which can likewise be better seen in FIGS. 2, 4, 5, and 6, and is subsequently described in greater detail. The closing surface 23 presses against the dispensing opening 15 in the first position of the valve element 13 and closes off said dispensing opening 15.

The sealing lip 16 spatially partitions a region of the valve chamber 12 from a further region. Said further region, in which the head spring 14 is arranged, is referred to as the spring space 19. On the end side opposite from the valve element 13, the liner 10 comprises a plug 20 that is slid into the liner 10. The plug 20 forms a contact surface of the head spring 14 and, at the same time, the transition between the fluid channel 8 and liner channel 9.

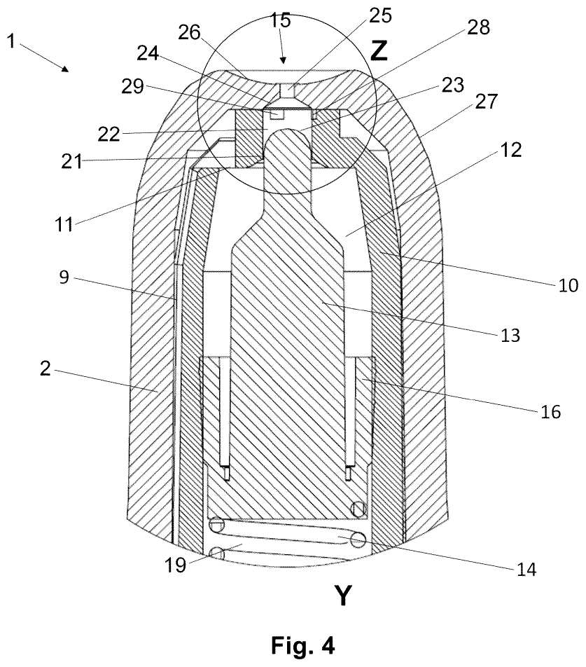

The valve element 13 and the liner 10 additionally seal against one another. This seal is denoted by the reference symbol 21, for example in FIG. 2, wherein the location of the seal 21 can be changed due to the different positions of the valve element 13 and the seal 21 does not require an explicit component characterization. Instead, the seal 21 results, as illustrated in FIG. 2, from a surface pressure. Furthermore, the seal 21 separates the valve chamber 12 from the nozzle chamber 22. In the first position of the valve element 13 illustrated in FIGS. 1 and 2, in which a hemispherical closing surface 23 of the valve element 13 bears against a cone 24 of the dispensing opening 15, the volume of the nozzle chamber 22 is very small and hardly distinguishable. The cone 24 has the shape of a truncated cone. A better depiction of the nozzle chamber 22 and of the cone 24 can be discerned in particular from FIGS. 4 through 6.

In FIG. 2, a detailed view of the forward region of the dispensing device 1 from FIG. 1 is illustrated, that is, of the section X.

As shown in FIGS. 1 and 2, the spherical closing surface 23 of the valve element 13 in the first position bears against the cone 24 such that the closing surface 23 protrudes, in regions, into a passage 25 of the dispensing opening. This means that the closing surface 23 protrudes, in regions, past the truncated cone, that is, past the top surface of the truncated cone, and into the passage 25.

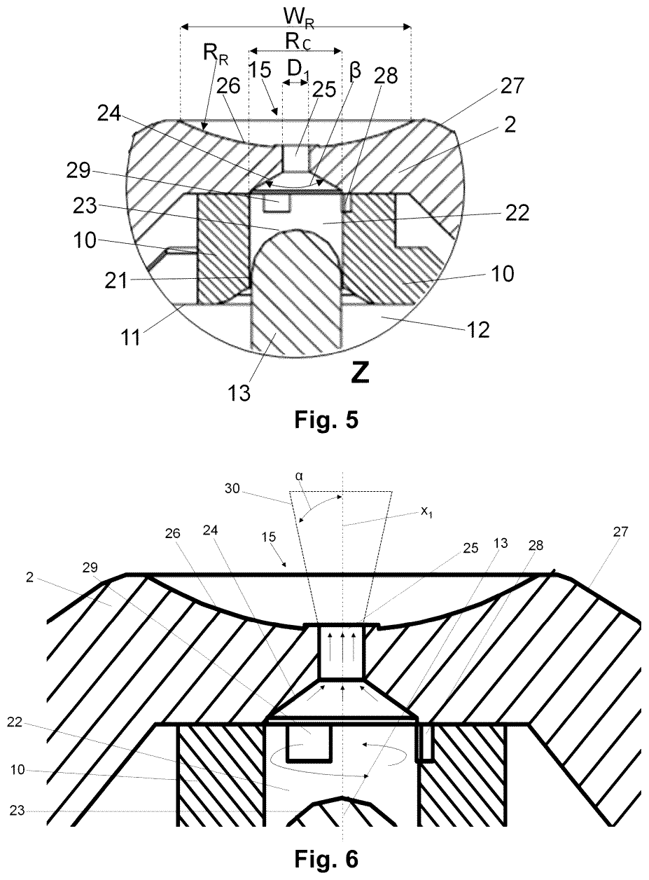

The cylindrical passage 25 has a passage diameter D₁, which is better discernible in FIG. 5. Preferably, D₁ lies between 0.2 and 0.6 mm. A diameter of 0.3 mm is particularly preferred. Furthermore, the passage 25 opens into a recess with a radial surface 26. The radius R_{R} of the radial surface 26 is thereby larger than the radius R_{C} of the base surface of the cone 24, which is opposite from the top surface of the cone 24, and wherein the top surface forms the transition from the cone 24 to the passage 25. Preferably, R_{R} is 3 mm and R_{C} is 0.5 mm. Furthermore, the radius of the passage 25 is smaller than the radius of the radial surface 26 and of the base surface of the cone 24 and corresponds to the radius of the top surface of the cone 24.

The width of the radial surface W_{R} is approximately 2.65 mm in the illustration shown. Furthermore, the cone has a cone angle β of approximately 120°. Preferably, the cone angle β lies in the range of 100° to 140°. The radius R_{R} of the radial surface 26, the radius R_{C} of the base surface of the cone 24, the width of the radial surface W_{R}, and the cone angle β are illustrated in FIG. 5. A spray angle α is also shown in FIG. 6.

The radial surface 26 forms a section of the outer contour 27 of the head base piece 2, wherein because the radial surface 26 is designed as a recess, the opening of the passage 25 lies behind a forward region of the head base piece 2 on the side of the radial surface 26.

Furthermore, FIG. 2 shows, in regions, a channel 28 which bypasses the seal 21 and opens into the nozzle chamber 22. A fluid can thus flow from the valve chamber 12 into the nozzle chamber 22 through the channel 28. The channel therefore constitutes the sole fluid connection between the valve chamber 12 and nozzle chamber 22. The fluid flow from the valve chamber 12 to the nozzle chamber 22 thus occurs past the seal 21.

In FIG. 3, the dispensing device 1 that is already illustrated in FIGS. 1 and 2 is shown in a second position of the valve element 13, wherein the closing cap 4 has been removed from the dispensing device 1. In the second position of the valve element 13, the valve element 13 has been displaced away from the dispensing opening 15 in an axial direction against the spring force of the head spring 14. A collection of fluid in the valve chamber 12 can be the cause thereof, which collection exerts a fluid pressure on the sealing lip 16 and moves the valve element. As a result of the movement of the valve element 13, both the volume of the valve chamber 12 and the volume of the nozzle chamber 22 are increased compared to the first position of the valve element 13.

As can be seen in the detailed view of the section Y from FIG. 3, which is illustrated in FIG. 4, and the detailed view of the section Z from FIG. 4, which is illustrated in FIG. 5, a channel opening 29 of the channel 28 is cleared as a result of the movement of the valve element 13 from the first position into the second position. A fluid that is under pressure in the valve chamber 12 can flow tangentially into the nozzle chamber 22 through the channel 28, which in the present case is a vortex channel.

An exemplary fluid flow is illustrated by solid arrows in FIG. 6, wherein the fluid entering into the nozzle chamber 22 from the channel opening 29 initially flows in a rotational movement through the nozzle chamber 22 to the cone 24. With the aid of the cone 24, the rotational movement of the fluid is converted into an axial movement, that is, essentially into a movement parallel to an axis x₁ that simultaneously forms the longitudinal axis of the dispensing device 1. The fluid is accelerated in the passage 25 and, upon exiting, forms a spray cone 30 with a spray angle α. For a better understanding of the invention, the spray cone 30 is illustrated by way of example using dashed lines. During a use of the dispensing device, the spray cone 30 is formed by drops of fluid.

In the embodiment described in relation to FIGS. 1 through 6, the identical features have been provided with the identical reference symbols. FIGS. 1 and 2 thereby depict a state of the dispensing device 1 in which the valve element 13 is arranged in a closed state, that is, in a first position. By contrast, in FIGS. 3 through 6, the same dispensing device 1 without a closing cap 4 is depicted in an open state, that is, in a state in which the valve element 13 is located in a second position.

To dispense the fluid, a user moves the head base piece 2 towards the snap-on element 3 in the axial direction after the closing cap 4 has been removed from the dispensing device 1. As a result, the cone 5 is moved against the spring force of the enclosure spring 7 in the interior of the enclosure 6. The volume in a pump chamber of the enclosure 6 thereby decreases. The pump chamber is formed by a space surrounding the enclosure spring 7. The conveyed amount of fluid is determined via a stroke of the cone 5 inside of the pump chamber. The dosage of a predetermined amount of fluid is hereby rendered possible. By resulting overpressure, the fluid is displaced into the fluid channel 8 from the pump chamber. The fluid is transported along the fluid channel 8 in an axial direction. The transport of the fluid continues along the liner 10 through the liner channel 9. At an axial end of the liner channel 9, the fluid ultimately passes through the breach 11 and enters the valve chamber 12.

In the embodiment illustrated here, a certain collection of fluid occurs in the valve chamber 12. The resulting pressure of the fluid on the valve element 13, or the sealing lip 16 that forms a type of screen, produces a counterforce against the spring force of the head spring 14, which is arranged in a spring space 19 sealed against the valve chamber 12. As long as the force applied to the valve element 13 by the fluid pressure is smaller than the force applied to the valve element 13 by the head spring 14, the valve element 13 is located in the first position and bears with the hemispherical closing surface 23 thereof against the cone 24 and closes off the dispensing opening 15, that is, the passage 25 in the direction of the radial surface 26. At the same time, the valve element 13, with the envelope surface thereof, closes off the channel opening 29 of the channel 28 that connects the valve chamber 12 to the nozzle chamber 22 past the seal 21.

Once the pressure in the valve chamber 12 is large enough to displace the valve element 13, said valve element 13 moves in a longitudinal direction inside of the liner 10 into a second position. Said second position can be defined by a stop, which is not illustrated, so that the valve element 13 is moved far enough that it strikes a stop. Due to the fluid pressure in the valve chamber 12, the fluid pushes through the channel 28 and through the outlet opening of the channel, that is, the channel opening 29, into the nozzle chamber 22. The smaller cross section of the channel 28 accelerates the fluid in the process. The use of a vortex channel additionally ensures a swirling of the fluid, which enters tangentially into the nozzle chamber 22.

During the movement of the valve element 13 from the first into the second position, the volumes of the nozzle chamber 22 and the valve chamber 12 increase. However, the valve element 13 and the liner 10 continue to seal against one another. The seal can, for example, occur with the aid of a surface pressure that is indicated in the figures by the reference symbol 21.

Once the fluid enters into the nozzle chamber 22, the fluid flows in a rotational movement through the nozzle chamber 22 in the direction of the dispensing opening 15. The cone 24 thereby ensures that the rotational movement of the fluid is converted into an axial movement, so that the fluid is conducted through the passage 25 essentially parallel to the axis x₁.

The fluid then exits the passage 25 and, in this case, produces the spray mist formed by drops, in the form of a spray cone 30. The spray cone initially has the spray angle α, wherein the angle α preferably lies between 15° and 70°. Particularly preferably, a is between 30° and 45°. The pressure inside of the valve chamber 12 decreases during the dispensing of fluid through the dispensing opening 15, provided that no additional fluid flows into the valve chamber 12 afterwards. As a result, the force which acts on the sealing lip 16 likewise decreases with the diminishing discharge of fluid out of the dispensing opening 15 of the dispensing device 1. Once the spring force of the head spring 14 is larger than the fluid pressure, the valve element 13 is once again located in the first position and therefore closes off the dispensing opening 15 until a fluid is, for example, pumped into the valve chamber 12 once more and the pressure in the valve chamber 12 increases again.

The embodiment according to the invention thus allows a stable, continuous, and lasting seal 21 between the liner 10 and valve element 13, which seal 21 is maintained independent of the movement of said valve element 13, wherein at the same time a fluid can be dispensed from the dispensing opening 15 in the form of a spray mist in the second position of the valve element 13. The invention thus allows, via few components and a simple structural design, the combination of a sealed pressure chamber 22, a valve chamber 12 that permits a buildup of pressure, and a nozzle that is formed from a nozzle chamber 22 and a dispensing opening 15, so that a fluid can be sprayed out in spray form. As a result of this simple design of the dispensing device 1, the dispensing device 1 can be produced in a particularly cost-efficient manner and is reliable and hardly susceptible to errors.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE SYMBOLS

1 Dispensing device
2 Head base piece
3 Snap-on element
4 Closing cap
5 Cone
6 Enclosure
7 Enclosure spring
8 Fluid channel
9 Liner channel
10 Liner
11 Breach
12 Valve chamber
13 Valve element
14 Head spring
15 Dispensing opening
16 Sealing lip
17 Inner wall (of the liner)
18 Closing surface
19 Spring space (of the head spring)
20 Plug
21 Seal (between valve element and liner)
22 Nozzle chamber
23 Closing surface
24 Cone
25 Passage
26 Radial surface
27 Outer contour (of the head base piece)
28 Channel
29 Channel opening
30 Spray cone
D₁ Passage diameter
R_{R} Radius of the radial surface
W_{R} Width of the radial surface
R_{C} Conc radius
α Spray angle
β Conc angle
x₁ Axis

What is claimed:

1. A dispensing device for dispensing a fluid, comprising:
a head base piece having a dispensing opening;
a liner arranged inside of the head base piece;
a valve element movably arranged inside of the liner,
wherein the valve element is arranged to be movable from a first position into a second position via a stroke relative to the liner,
wherein the valve element closes off the dispensing opening in the first position and clears the dispensing opening in the second position, and
wherein the valve element and the liner, which seal against one another in the first position and in the second position, form a nozzle chamber and a valve chamber, and
a channel connects the valve chamber and the nozzle chamber to one another.

2. The dispensing device according to claim 1, wherein the channel is a vortex channel that is embodied, at least in regions, in a shape of a helix.

3. The dispensing device according to claim 1, wherein the channel is embodied, at least in regions, inside of the liner.

4. The dispensing device according to claim 1, wherein the valve element closes off a channel opening into the nozzle chamber when the valve element is located in the first position.

5. The dispensing device according to claim 1, wherein the nozzle chamber has a smaller volume than the valve chamber in the first position and in the second position.

6. The dispensing device according to claim 1, wherein the channel is configured to introduce a fluid tangentially into the nozzle chamber.

7. The dispensing device according to claim 1, further comprising a head spring that presses the valve element against the dispensing opening in the first position.

8. The dispensing device according to claim 7, wherein the valve element additionally comprises a sealing lip arranged to seal the valve chamber against the head spring.

9. The dispensing device according to claim 1, further comprising a stop that limits the movement of the valve element via the stroke from the first position into the second position.

10. The dispensing device according to claim 9, wherein the liner comprises the stop that limits the movement of the valve element via the stroke from the first position into the second position.

11. The dispensing device according to claim 1, wherein the valve element comprises a hemispherical closing surface which bears against the dispensing opening in the first position.

12. The dispensing device according to claim 1, wherein the dispensing opening comprises a cone which interacts with the hemispherical closing surface.

13. The dispensing device according to claim 12, wherein the dispensing opening comprises a radial surface which forms a portion of an outer contour of the head base piece.

14. The dispensing device according to claim 13, wherein the dispensing opening comprises a passage that connects the cone and the radial surface.

15. The dispensing device according to claim 1, wherein the liner comprises a breach which is configured such that a fluid can flow through the breach into the liner.

16. The dispensing device according to claim 1, wherein the dispensing opening produces a maximum spray cone of 70° in a second position of the valve element.
